(19) United States
(12) Patent Application Publication
(10) Pub. No.: US 2026/0014570 A1
(43) Pub. Date: Jan. 15, 2026

(54) CENTRIFUGE

(71) Applicant: Eppendorf Himac Technologies Co., Ltd., Ibaraki (JP)

(72) Inventor: Hidetaka Osawa, Ibaraki (JP)

(73) Assignee: Eppendorf Himac Technologies Co., Ltd., Ibaraki (JP)

(21) Appl. No.: 18/994,622

(22) PCT Filed: Jul. 27, 2023
(86) PCT No.: PCT/JP2023/027490

§ 371 Date: Jan. 15, 2025

(30) Foreign Application Priority Data
Aug. 5, 2022 (JP) 2022-125188

(51) Int. Cl. B04B 9/10

(52) U.S. Cl. CPC B04B 9/10

(57) ABSTRACT

In a centrifuge which employs a rotation detector for generating M-number (where M≥1) of pulse signals per rotation of a motor, a control unit compares a time interval T (n−1, m) of a pulse signal one rotation before an immediately preceding pulse detected by a rotation detector with a time interval T (n, m) of a recent detection pulse signal, and then, from an increase or decrease between the time interval T (n−1, m) and the time interval T (n, m), calculates the rotational speed by using a formula of rotational speed N (n, m)=N (n−1, m)×T (n−1, m)÷T (n, m).

### TECHNICAL FIELD

The present invention accurately performs rotational speed detection of a rotor in a centrifuge that rotates the rotor.

### RELATED ART

A centrifuge (centrifugal separator) performs separation of a sample by rotating a rotor containing the sample at high speed. Various shapes of rotors may be mounted, such as angle rotors and swing rotors, and the size of the rotor differs depending on the size of the container holding the sample. In a centrifuge, it is important to accurately detect the rotational speed of the rotor. Patent Document 1 is known as a centrifuge that performs such speed detection. In the centrifuge of Patent Document 1, the rotor is attached to the rotation axis of the motor, and since the motor and rotor rotate synchronously, the rotational speed of the rotor was detected by detecting the rotational speed of the motor. A speed detector is provided on the rotation axis of the motor in the centrifuge, and the rotational speed of the rotor is detected by measuring the time of one round of pulse signals generated during rotation.

In conventional centrifuges, when the rotational speed of the rotor is in an extremely low-speed range, the rotational speed may be calculated from one pulse or several pulses that are less than one full rotation of the motor, rather than from one full rotation. However, in the case of an encoder where the pulse generation intervals are not uniform and have slight variations, there was a risk of generating significant errors in detecting the rotational speed in the extremely low-speed rotation range. To eliminate this error, a method of detecting the rotational speed of the rotor by also using the output of a sensor that detects a magnet provided on the bottom surface of the rotor with a hall element may be considered. However, this method cannot be applied in cases where a magnet is not provided on the rotor side.

### CITATION LIST

### Patent Literature

Patent Document 1: Japanese Patent Application Laid-Open Publication No. 2005-230750

### SUMMARY OF INVENTION

### Technical Problem

To improve the rotational speed detection accuracy of Patent Document 1, a high-precision rotation detector for detecting the motor's rotational speed may be installed on either the motor or the rotor. However, installing a new rotation detector would require modifying the structure of the centrifuge, which would be a factor in increasing manufacturing costs.

The present invention has been made in view of the above background, and its objective is to provide a centrifuge capable of accurately detecting the rotational speed of the rotor even in the low-speed range.

Another objective of the present invention is to realize a centrifuge that switches the rotational speed detection control of the rotor based on each state of acceleration, constant speed, and deceleration of the rotor.

A further objective of the present invention is to realize a centrifuge that switches the rotational speed detection control of the rotor according to the rotational speed range of the rotor.

### Solution to Problem

The representative features of the inventions disclosed in this application are described as follows.

According to one feature of the present invention, a centrifuge includes a rotor for holding a sample; a motor for rotationally driving the rotor; a rotation detector for detecting rotation of the motor; and a control unit for controlling the rotation of the motor based on an output from the rotation detector. The rotation detector generates M-number of pulse signals (where M≥1) per rotation of the motor, and in an n^{th} speed detection, the control unit compares a time interval T (n, m) of an immediately preceding pulse signal detected by the rotation detector (where m indicates an m^{th} pulse in one round, and 1≤m≤M) with a time interval T (n−1, m) of a pulse signal one rotation before the pulse, and calculates a rotational speed N of the rotor from increase or decrease between the time interval T (n−1, m) and the time interval T (n, m). Furthermore, in addition to the rotational speed N for each round, a rotational speed N (n, m) of smaller intervals is calculated by N (n, m)=N (n−1, m)×T (n−1, m)÷T (n, m).

According to another feature of the present invention, a rotation control of the rotor includes an acceleration control that increases the rotational speed of the rotor over time, and a deceleration control that decreases the rotational speed of the rotor over time, and a constant speed control (stabilization) that rotates at a constant rotational speed. The speed calculation from the increase or decrease in the pulse time interval T (n, m) of the pulse is performed during acceleration control or deceleration control of the rotor. Moreover, the control unit calculates the speed from the increase or decrease in the time interval T (n, m) of the pulse in a speed range where the rotational speed of the rotor is lower than a predetermined threshold speed. In a speed range where the rotational speed of the rotor is higher than the threshold speed, a rotational speed (unit: per minute) of the pulse signal for each rotation of the motor is calculated by N (n)=60/[T (n, 1)+T (n, 2)+ . . . T (n, m)+ . . . +T (n, m)]. The rotation detector includes a disk attached to a rotation axis of the motor and for transmitting or blocking light, and a photointerrupter attached to a non-rotating part of the motor, and M-number of pulse signals from the photointerrupter are output per rotation of the motor. Further, the rotation detector may include multiple magnets attached to the rotor, and a magnetic detection element attached to a non-rotating part near the rotor, and may be configured such that M-number of pulse signals from the magnetic detection element are output per rotation of the motor.

According to yet another feature of the present invention, in the centrifuge, the rotation detector includes a pulse time comparison speed detection mode that performs multiple speed detections within one round of the motor, and a normal speed detection mode that performs speed detection for each round of the motor. The control unit is configured to accurately detect a rotational speed of the motor in the pulse time comparison speed detection mode when the speed is lower than a switching threshold speed of speed detection mode, and to detect the rotational speed of the motor in the normal speed detection mode when the speed is equal to or higher than the switching threshold speed of speed detection mode. The rotation detector generates M-number (where M>1) of pulse signals per rotation of the motor. In the pulse time comparison speed detection mode, the control unit detects a time interval T (n−1, m) of a pulse signal one full rotation before an immediately preceding pulse, and calculates speed by: rotational speed N (n, m)=N (n−1, m)×T (n−1, m)÷T (n, m). Moreover, in the pulse time comparison speed detection mode of the centrifuge, the control unit is configured to detect a sum of time intervals T (n−1, m=1, . . . M) of pulse signals from an immediately preceding pulse detected by the rotation detector to one full rotation before, and each time when detecting a width P (n, m) of the pulse signal, calculate speed by: rotational speed N (n, m)=60/[T (n−1, 1)+T (n−1, 2)+ . . . +T (n−1, m)]×T (n−1, m)÷T (n, m).

### Effects of Invention

According to the present invention, in a centrifuge equipped with a rotation detector such as an encoder on the motor, the rotational speed is calculated based on the time change between the detected pulse and the pulse at the same rotation position one round earlier. Thus, even if there are variations in the intervals of each pulse of the output signal from the rotation detector, the rotational speed can be calculated stably. Moreover, even in cases where the rotational speed is detected using non-equidistant pulse signals, such as when identifying the rotor by detecting the magnetized position with a Hall IC, or when pulse signals used to detect the rotational speed using a rotor that generates pulses to is relatively prone to variation, the rotational speed can be accurately detected without being affected by factors such as magnetic force strength or distance. The speed detection method of the present invention is an effective rotational speed detection technique for both ordinary rotation detectors that do not have high-precision pulse generation intervals and rotation detectors intentionally created with non-uniform pulse generation intervals. Moreover, this method is effective for speed detection in the relatively low range of motor rotational speeds.

### BRIEF DESCRIPTION OF DRAWINGS

FIG. 1 A vertical cross-sectional diagram showing the overall configuration of a centrifuge 1 according to an embodiment of the present invention.

FIG. 2 (a) is a perspective diagram of a different form of a rotor 120 that may be mounted on the centrifuge 1 of FIG. 1, and (b) is a perspective diagram of the motor 8 used in the centrifuge 1 of FIG. 1.

FIG. 3 A time chart showing the operation status using the centrifuge 1 according to an embodiment of the present invention, and the rotational speed of a rotor 20.

FIG. 4 A diagram showing an output signal 90 from a rotation detector 85 of FIG. 2.

FIG. 5 A table for illustrating the types of time T (n) and rotational speed N (n) calculated from the output signal 90 of FIG. 4.

FIG. 6 A diagram illustrating the method of calculating the rotational speed N from the waveform of the output signal 90 shown in FIG. 4.

FIG. 7 A diagram illustrating another method of calculating the rotational speed N from the waveform of the output signal 90 shown in FIG. 4.

FIG. 8 A flowchart showing the speed detection procedure of the centrifuge 1 according to the second embodiment of the present invention (Part 1).

FIG. 9 A flowchart showing the speed detection procedure of the centrifuge 1 according to the second embodiment of the present invention (Part 2).

### DESCRIPTION OF THE EMBODIMENTS

### Embodiment 1

The embodiments of the present invention will be described below based on the drawings. In the following drawings, the same parts are given the same reference numerals, and repeated descriptions are omitted. Moreover, in this specification, the front-back and up-down directions are described as the directions shown in the drawings.

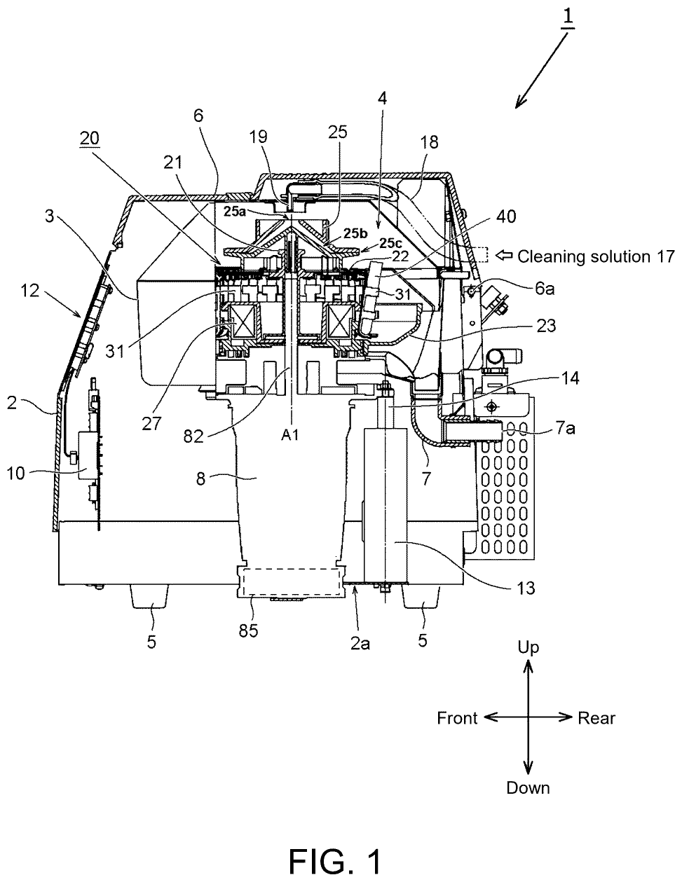

FIG. 1 is a vertical cross-sectional diagram showing the overall configuration of a centrifuge 1 according to the present invention. The centrifuge 1 includes a chassis (frame) 2 having a square cross-sectional shape when viewed from above, a door 6 that opens and closes the upper part of a chassis 2, and a chamber 3 placed inside this chassis 2. A rotor 20 is rotated inside the chamber 3 (rotor room 4). The chassis 2 has multiple foot parts 5 and is installed on a table or the like. The door 6 is an opening and closing type that may swing up and down on the front side, centered on a hinge 6a provided on the rear side. A motor 8 with a rotation axis 82 is placed below the chamber 3, and the rotor 20 is attached to the upper end of the rotation axis 82. The motor 8 is, for example, a brushless motor, and its number of rotations (rotational speed) may be controlled by a control unit 10. A rotation detector 85 is provided on the motor 8 to detect the number of rotations of the rotation axis. To fix the motor 8 to a base part 2a of the chassis 2, a cylindrical pillar (pole) 13 is provided, and a rubber damper 14 is placed between the motor 8 and a pillar 13 to reduce the vibration of the rotor 20 and the motor 8. An operation display panel 12, composed of a touch-type liquid crystal display panel or the like, is provided on the front side surface of the chassis 2. The operation display panel 12 is a means for inputting information from the user and a means for displaying information (e.g., operation elapsed time, rotational speed (rpm)) from the control unit 10.

The rotor 20 is a dedicated rotor for cell washing and has multiple (for example, 24) test tube holders 31 arranged at equal intervals in the circumferential direction when viewed from above. The test tube holders 31 are supported by a rotor plate 22 of the rotor 20 on their inner circumferential side surfaces so as to be swing (rotate) freely in the centrifugal direction (radial direction). The test tube holders 31 are made of magnetic material and hold test tubes 40 by inserting them from top to bottom. Inside each test tube 40 (only one is shown in FIG. 1), a sample (liquid) containing living cells such as red blood cells is pre-filled, and before the start of the centrifugal separation operation, the test tubes 40 filled with the sample are set by the operator's hand into each of the test tube holders 31.

The rotor 20 includes a holding part 27 for holding the longitudinal center axis of the test tube holders 31 at a vertical or nearly vertical small oscillation angle. The holding part 27 keeps the metal test tube holders 31 at a state of being unable to swing by adsorbing them with magnetic force, and uses magnetic elements such as electromagnets. The holding part 27 may electrically switch between the adsorbed state (fixed state or non-swinging state) and the released state (swingable state) of the test tube holders 31. When the test tube holders 31 are in the adsorbed state, they function as an angle rotor with a so-called negative swing angle, and when the test tube holders 31 are in the released state, they function as a so-called swing rotor. A swing angle θ formed between the longitudinal direction of the test tubes in the released state and a rotation axis line A1 is approximately 45 degrees.

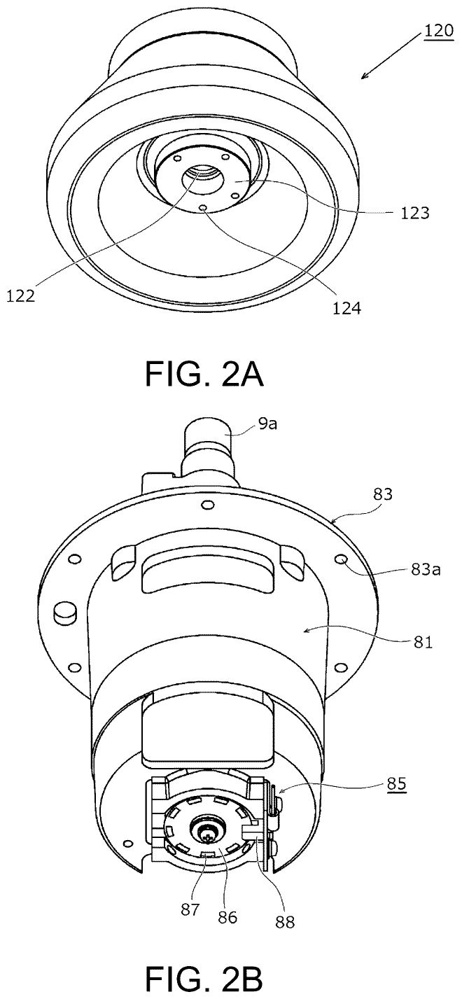

The rotor 20 for cell washing is detachable from the rotation axis 82. Thus, it is also possible to attach a normal angle rotor (for example, see (a) of FIG. 2) that is unable to supply a cleaning solution 17 during rotation, or a different swing rotor (not shown) to the rotation axis 82. In the case of attaching the rotor 20 for cell washing like in this embodiment to the rotation axis 82, a cleaning solution distribution element 25 is installed on the upper part of the rotor 20, and the cleaning solution 17 or other liquid is supplied into the test tubes 40 during rotation (swinging) of the rotor 20 using a cleaning solution supply pipe 18 provided inside the door 6. The cleaning solution distribution element 25 is inserted into a rotation axis guide member 21 and installed on top of the rotor 20 so as to rotate integrally with the rotor 20 which carries test tube holders 31 in a circular row.

At the upper part of the cleaning solution distribution element 25, a nozzle 19, which serves as the outlet of the cleaning solution supply pipe 18, is positioned on the rotation axis line A1, and the liquid falling from the nozzle 19 flows into a cleaning solution inlet 25a located at the upper side of the cleaning solution distribution element 25. The cleaning solution distribution element 25 has the cleaning solution inlet 25a at the upper part on the rotation axis line A1, and forms a space connected to a cleaning solution passage 25b having a conical internal space. The outer edge of the cleaning solution passage 25b is divided in the circumferential direction, and multiple cleaning solution injection ports 25c extending in the radial direction are formed.

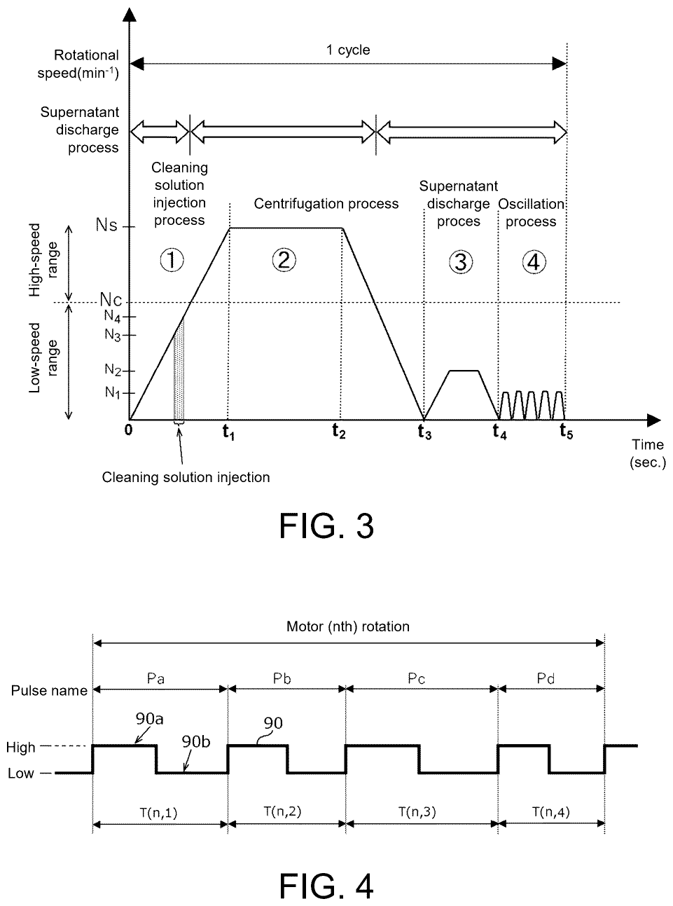

A pump (not shown) is connected to the outer end (the end away from the nozzle 19) of the cleaning solution supply pipe 18 that supplies the cleaning solution 17 to the cleaning solution distribution element 25. By turning on the power supply of the pump by the control unit 10, the cleaning solution 17 may be supplied from an external cleaning solution tank (not shown) through the cleaning solution supply pipe 18 to the nozzle 19 located at the upper part of the centrifuge 1. In the cleaning solution injection process to be described later, the cleaning solution 17 ejected downward from the nozzle 19 enters the central part of the cleaning solution distribution element 25 rotating integrally with the rotor 20, is distributed to the outer periphery by the centrifugal force inside the cleaning solution distribution element 25, branches into the same number of flow paths as the test tubes 40 (24 tubes) held in the test tube holders 31, and is forcefully injected into each test tube 40 from the cleaning solution injection ports 25c of the cleaning solution distribution element 25. For this injection of the cleaning solution 17 into each test tube 40, it is important to maintain the rotational speed of the rotor 20 within a predetermined range (a range of rotational speed N₃ to N₄ in FIG. 3 to be described later).

A bowl-shaped bottom surface part 23 is formed at the lower part of the rotor 20. The bottom surface part 23 is a container for receiving the cleaning solution 17 that spills without entering the test tubes 40, and also serves as a stopper for limiting the swing angle θ of the test tube holders 31. In other words, the test tube holders 31 holding the test tubes rotate in the radial horizontal direction of the circumference of the rotor 20, tilt until the lower part of the test tube holders 31 contacts the outer edge of the bottom surface part 23, and in that contacted state, centrifugally separate the samples such as blood cells in the test tubes 40. As the cleaning solution 17 is injected while the rotor 20 is rotating, and excess cleaning solution 17 is discharged from inside the test tubes 40, spilled cleaning solution 17 accumulates at the bottom surface part of the chamber 3. Thus, a drain hose 7 is connected to a part of the bottom surface of the chamber 3, and its discharge port 7a is arranged to extend to the outside of the chassis 2. The user collects or disposes of the excess cleaning solution (waste liquid) using a hose or the like at the end of the discharge port 7a.

(a) of FIG. 2 is a perspective diagram of a different form of a rotor 120 that may be mounted on the centrifuge 1 shown in FIG. 1. The rotor 120 is a so-called angle rotor and is a different rotor from the rotor 20 shown in FIG. 1. Various types of rotors, such as angle rotors and swing rotors, may be mounted on the centrifuge 1. On the upper side of the rotor 120, multiple holding holes (not visible in the diagram) for holding the multiple test tubes 40 are arranged at equal intervals in the circumferential direction. A mounting hole 122 that may fit onto a crown 9a shown in (b) of FIG. 2 is formed at the tip of the rotation axis of the motor 8. A ring part 123, which forms a circular bottom surface, is formed around the mounting hole 122, and multiple identifiers 124 for identifying the rotor 120 are provided in the circumferential direction of the ring part 123. The shape of the mounting hole 122 that receives the crown 9a of the rotor 120, and the size and vertical position of the ring part 123 arranged on the outer circumference of the mounting hole 122, are compatible with other rotors including the rotor 120. The identifiers 124 are formed or arranged to detect the rotating rotor 120 from outside the rotor, and the identifiers 124 are, for example, formed by recesses created on the circular surface made of aluminum alloy or titanium alloy, or constructed by forming a recesses and inserting a cylindrical magnet.

(b) of FIG. 2 is a perspective diagram of the motor 8 used in the centrifuge 1 shown in FIG. 1. The rotor and stator of the motor 8, which are not shown, are housed inside a motor housing 81, and the upper and lower sides of the rotation axis 82 are formed to extend in the axial direction above and below the motor housing 81. A flange part 83 is formed on the upper side of the motor housing 81, and multiple screw holes 83a are formed in the flange part 83. The crown 9a is connected to one side of the rotation axis 82. On the other side (lower end side) of the motor's rotation axis 82, a detection means for detecting the rotational speed of the motor 8, namely the rotation detector 85, is provided. The rotation detector 85 is composed of an encoder disk 86 fixed to the lower end side of the rotation axis 82, and a photointerrupter 88 that outputs a rotation pulse signal based on the presence or absence of slits 87 in the encoder disk 86. By inputting the output signal (rotation pulse signal) 90 (refer to FIG. 4 described later) output from the photointerrupter 88 to the control unit 10, and measuring the time interval of an output signal 90 with an oscillator (clock) not shown in the drawing, the control unit 10 is able to detect the number of rotations of the motor 8.

Next, the execution procedure of the washing cycle will be described using FIG. 3. FIG. 3 is a time chart showing the rotational speed of the rotor 20 in the washing cycle. In the centrifuge 1 for cell washing used to wash living cells such as blood cells, in addition to the process of acceleration-constant speed-stop of the rotor 20 as in a normal centrifuge (corresponding to time t₁ to t₃), it includes a cleaning solution injection process indicated by enclosed number 1, and furthermore, after the centrifugal separation operation is completed (after time t₃), it includes a supernatant discharge process indicated by enclosed number 3 and an oscillation process indicated by enclosed number 4.

Initially, from time 0 to time t₁, the motor 8 is started to accelerate the rotor 20 to the centrifugal separation rotational speed N₃. At this time, the swing of a test tube holder 31 is in a free state, that is, in a state where the test tube holder 31 is not adsorbed by the holding part 27 (refer to FIG. 1). When the swing amount of the test tube holder 31 reaches its maximum during the acceleration of the rotor 20 at the rotational speed N₃ (approximately 1200 rpm), the cleaning solution 17 is dropped downward from the nozzle 19, and injected into the interior of the cleaning solution distribution element 25 through the cleaning solution inlet 25a. The cleaning solution 17 that has entered the interior of the cleaning solution distribution element 25 is distributed and supplied to the interior of the multiple test tubes 40 through the cleaning solution passage 25b via the cleaning solution injection port 25c from the upper opening of the test tube in the swung state. The cleaning solution 17, such as physiological saline, is vigorously injected into each test tube 40 from the cleaning solution distribution element 25 by centrifugal force. At this time, the blood cells in the test tube 40 are sufficiently suspended in the physiological saline.

At the rotational speed N₄ in the middle of the acceleration interval, the injection of the cleaning solution 17 is completed, and when the rotational speed of the rotor 20 reaches a set rotational speed N_{S} for centrifugal separation operation at time t₁, the operation is performed for the set time (centrifugal separation operation time=t₂−t₁), and the sample moves to the bottom by centrifugal force in the cleaning solution. At time t₂, when the centrifugal separation operation at speed N_{S} for the set time period is completed, the control unit 10 decelerates the motor 8 to stop the rotation of the rotor 20.

At time t₃, when the rotation of the rotor 20 stops, the supernatant discharge process indicated by enclosed number 3 is performed. In this discharge process, the test tube holder 31 is adsorbed by energizing the coil of the holding part 27. At this time, the state of the test tube 40 is such that its longitudinal center axis is tilted with the opening part slight outward from the vertical direction. In this state, the rotor 20 is accelerated to a set speed N₂, operated for a certain time to decelerate the rotor 20. By rotating the rotor 20 with the angle of the test tube 40 slightly in a negative state, the supernatant rises along the inner wall surface of the test tube 40 due to centrifugal force and is discharged to the outside, resulting in most of the supernatant being discharged outside the test tube 40.

At time t₄, when the rotor 20 stops, the oscillation process is executed next. The oscillation process (AGITATE) is a process to agitate the remaining cleaning solution 17 and the sample by oscillating the test tube holder multiple times in a short period. Here, the rotational speed of the rotor 20 is accelerated to N₁, rotated at a constant speed for a short time, and then immediately decelerated. This operation of acceleration-constant speed-deceleration-stop, which involves repeated small rotations and stops, is executed multiple times (in this case, 5 times). The above washing cycle from enclosed number 1 to enclosed number 4 is repeatedly executed multiple times, for example, about 3 to 4 times.

In the above-mentioned cleaning solution injection process, the supernatant discharge process indicated by enclosed number 3, and the oscillation process indicated by enclosed number 4, it is important to precisely control the rotational speed of the motor 8. For the normal rotational speed of the motor 8, the rotational speed N is calculated by measuring the pulse interval for one round from the pulse-like output signal 90 of the rotation detector 85. In the low-speed range of the rotational speed, the rotational speed is sometimes calculated from the time of one pulse period rather than one full rotation of the motor. FIG. 4 shows an example of the output signal 90 of the pulses generated by this rotation detector 85. In FIG. 4, for simplification of explanation, the output signal 90 is shown for a configuration where the number of slits 87 in the encoder disk 86 of the rotation detector 85 is four, and four pulses Pa, Pb, Pc, and Pd are output from the photointerrupter 88 when the motor 8 makes one round.

The output signal 90 is such that in parts where the slits 87 of the encoder disk 86 do not exist and light does not pass through, the output of the photointerrupter 88 becomes high (e.g., arrow 90a), and when light passes through the slits 87, the output of the photointerrupter 88 becomes low (e.g., arrow 90b). The interval of each pulse of the output signal 90 is accurately measured by counting the interval with an oscillator (clock) not shown in the drawing. Here, array (n, m) is used, in which n is a variable indicating which round of rotation of the motor 8 it is (n is an integer: 0<n), and m is a variable indicating the order from the leading pulse during each rotation (m is an integer: 0<m≤M. M represents the number of slits 87, here M=4). Thus, the time interval of pulse Pa in the n^{th} rotation shown in FIG. 4 is indicated as T (n, 1), the time interval of Pb in the n^{th} rotation is indicated as T (n, 2), the time interval of Pc in the n^{th} rotation is indicated as T (n, 3), and the time interval of Pd in the n^{th} rotation is indicated as T (n, 4). Moreover, in the case where the number of slits 87 in the encoder disk 86 is M (M>4), during the n^{th} round of the rotor 20, M time intervals from T (n, 1) to T (n, 2), . . . T (n, m) are measured.

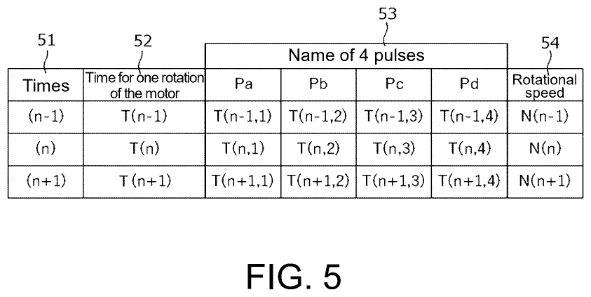

FIG. 5 is a table illustrating the types of time T (n) and rotational speed N (n) calculated from the output signal 90 in FIG. 4. Similar to conventional rotation detectors, without subdividing for each pulse, the time T (n) indicated by mark 52 is the time measured for the rotor 20 to make one round on the n^{th} time, and the rotational speed N (n) indicated by mark 54 is the speed for the one round. The control unit 10 measures the time intervals T (n, 1), T (n, 2), T (n, 3), and T (n, 4) respectively for each pulse Pa, Pb, Pc, and Pd that appears when the rotor 20 makes one round on the n^{th} rotation (unit: seconds). Then, the time 52 required for the rotor 20 to make one round on the n^{th} time may be calculated as the following (unit: seconds):

$$T ( n ) = T ( n , 1 ) + T ( n , 2 ) + T ( n , 3 ) + T ( n , 4 ) .$$

With the T (n), the rotational speed N (n) per minute of the rotor 20 on the n^{th} rotation may be calculated as the following:

$$N ( n ) = 60 \div T ( n ) .$$

For such calculation, in this embodiment, the time interval T (n, m) of the pulse period indicated by mark 53 is measured for each pulse (Pa, Pb, Pc, Pd) of one full rotation of the motor, and temporarily stored in the memory area of the control unit 10, and the pulse period time before one rotation is compared with the recent pulse period time (after one rotation). Then, the motor speed is calculated from the ratio of increase or decrease in the measurement time of the same pulse signal. The memory area may be RAM included in the control unit 10 or a dedicated buffer memory, and by using the values of T (n−1, m) (where m=1-4) for the immediately preceding round stored in this memory, speed detection with higher accuracy than conventional methods can be performed.

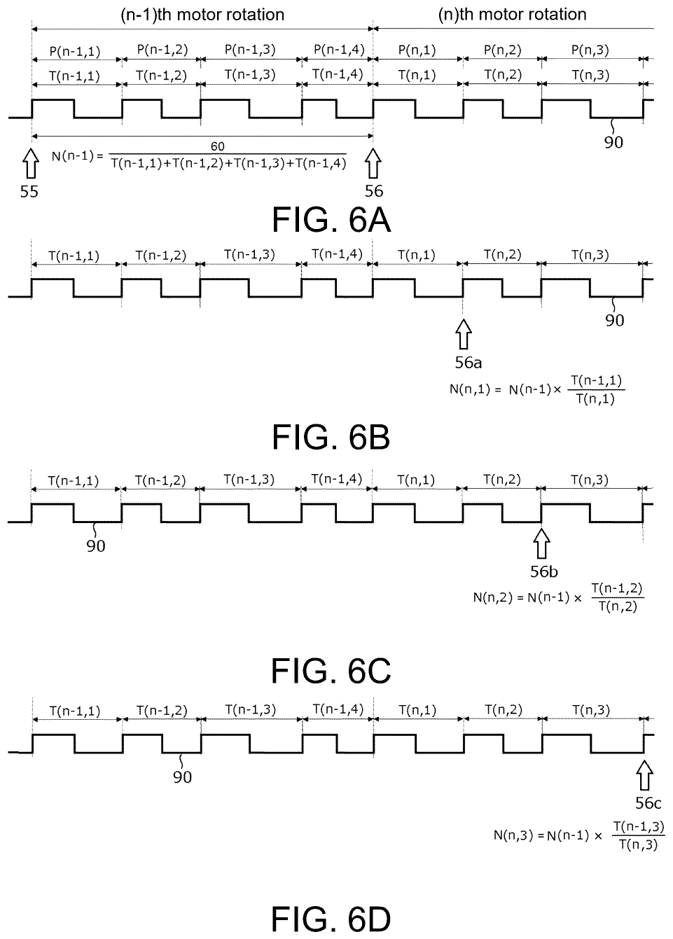

FIG. 6 is a diagram illustrating the method of calculating the rotational speed N from the waveform of the output signal 90 shown in FIG. 4. The waveform from the position of arrow 55 to the position of arrow 56 in the output signal 90 shown in FIG. 6 is the output waveform of the rotation of the output signal 90 shown in FIG. 5 one round before (n−1 rotation). Here, to identify pulses Pa, Pb, Pc, and Pd, P (n−1, 1), P (n−1, 2), P (n−1, 3), and P (n−1, 4) are denoted, indicating which round of rotation of the motor and which pulse it is. In practice, the control unit 10 does not need to identify which round of rotation of the motor it is, and it is sufficient to temporarily store the measured values from one or several rounds before the current rotation (n^{th} rotation) in the buffer memory.

At the point of arrow 56, the rotational speed N (n−1) of the motor may be calculated by the equation shown at the bottom of (a) of FIG. 6. In conventional centrifuges, the next speed detection after this point of arrow 56 would occur after the motor 8 has rotated once from arrow 56. This method of measuring rotational speed each round is referred to as the “normal speed detection mode” in this specification. In this embodiment, in addition to the “normal speed detection mode”, a “pulse time comparison speed detection mode” is established to calculate the rotational speeds N (n, 1), N (n, 2), and N (n, 3) at three additional timings indicated by arrows 56a, 56b, and 56c where pulse P appears during the process leading to the next measurement timing after one round from arrow 56.

Focusing on pulse P (n, 1) for explanation, if the rotational speeds of the (n−1)^{th} and (n)^{th} rotations are the same, T (n−1, 1)=T (n, 1). When the motor 8 is accelerating and the acceleration gradient is constant, the period of pulse P becomes shorter at a constant ratio. When the motor 8 is decelerating and the deceleration gradient is constant, the period of pulse P becomes longer at a constant ratio. Noting that the rate of change in rotational speed is almost equal to the ratio of T (n−1, 1)÷T (n, 1), in this embodiment, the rotational speed at the input of pulse P (n, 1) is calculated by multiplying the previous rotational speed N (n−1) by the change ratio of rate of change in the rotational speed. Thus, the rate of change in the previously detected rotational speed of the motor 8 is multiplied by this ratio, and the following is calculated:

$$N ( n , 1 ) = N ( n - 1 ) \times T ( n - 1 , 1 ) \div T ( n , 1 ) .$$

This measurement method allows for speed detection 4 times per round, rather than once per round. This number is equivalent to M, the number of occurrences of pulse signals per round from the rotation detector 85.

Similarly, at the point of arrow 56b, the rate of change in the rotational speed of the motor 8 is the ratio of T (n−1, 2) to T (n, 2). Thus, the previously detected rotational speed N (n−1) may be multiplied by this ratio by, and the following is calculated:

$$N ( n , 2 ) = N ( n - 1 ) \times T ( n - 1 , 2 ) \div T ( n , 2 ) .$$

At the point of arrow 56c, the rate of change in the rotational speed of the motor 8 is the ratio of T (n−1, 3) to T (n, 3). Thus, the previously detected rotational speed N (n−1) may be multiplied by this ratio, and the following is calculated:

$$N ( n , 3 ) = N ( n - 1 ) \times T ( n - 1 , 3 ) \div T ( n , 3 ) .$$

Next, in the state where the motor 8 has rotated approximately 90 degrees from arrow 56c, that is, at the point of one rotation from arrow 56, the same equation as in (a) of FIG. 6 may be used, namely, the following is calculated:

$$N ( n ) = 60 \div ( T ( n , 1 ) + T ( n , 2 ) + T ( n , 3 ) + T ( n , 4 ) ) .$$

Subsequently, the rotational speed of the motor 8 is detected and calculated while repeating the same method. In this embodiment, since the rotational speed N is calculated from the time change of pulses corresponding to the same slit 87 for the speed change, the rotational speed may be calculated stably even if each pulse is non-uniform. Moreover, even in cases where the rotational speed is detected using non-equidistant pulse signals, such as when detecting the magnetized position with a Hall IC to identify the rotor, or in cases where the pulse signals are relatively easy to vary due to being easily affected by magnetic force strength or distance, the rotational speed can be accurately detected. Thus, this is an effective rotational speed detection method for non-uniform pulse generators. Furthermore, the speed detection method according to this embodiment is effective for speed detection in a relatively low range of motor rotational speed.

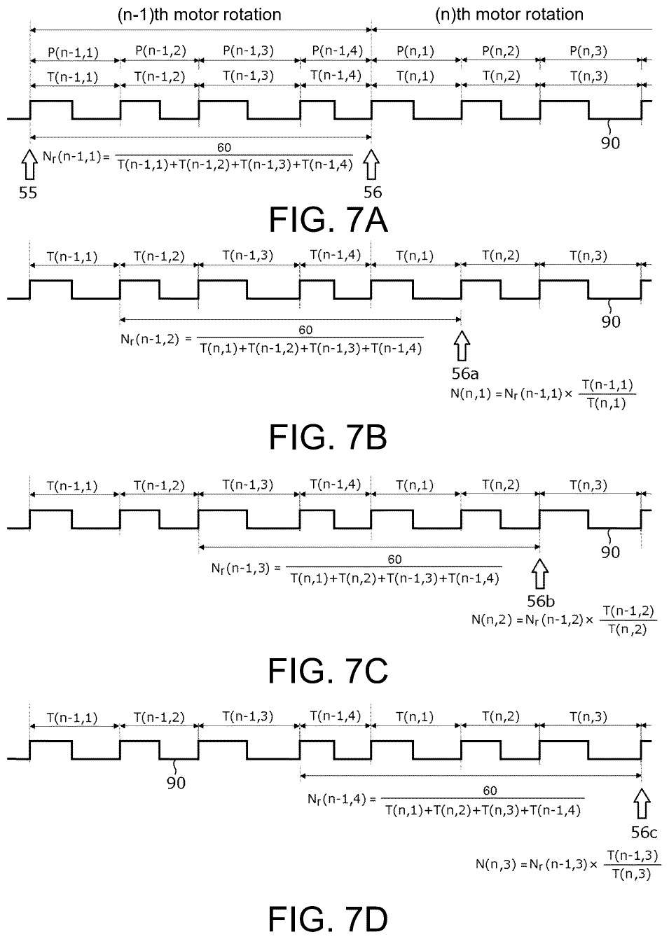

FIG. 7 is a diagram illustrating another method of calculating the rotational speed N from the waveform of the output signal 90 shown in FIG. 4. While in FIG. 6, the rotational speed N was calculated by multiplying the rate of change of the rotational speed of the motor 8 for each pulse generation with respect to the rotational speed N (n−1), FIG. 7 differs in that it calculates by multiplying the rate of change of the rotational speed of the motor 8 with the rotational speed Nr for the immediately preceding round each time, allowing for obtaining a more instantaneous rotational speed N.

In (a) of FIG. 7, the rotational speed Nr (n−1, 1) is calculated from the time for one full rotation of the (n−1)^{th} rotation of the motor between arrows 55 and 56. For example, the first one-rotation rotational speed at the start of rotation is calculated from the time for one full rotation of the motor 8. At the point of arrow 56a in (b) of FIG. 7, the rate of change of the rotational speed of the motor 8 is T (n−1, 1)÷T (n, 1), so the previously detected rotational speed Nr (n−1, 1) may be multiplied by this ratio, and the following is calculated:

$$N ( n , 1 ) = N r ( n - 1 , 1 ) \times T ( n - 1 , 1 ) \div T ( n , 1 ) .$$

The pulses for one full rotation of the motor 8 at the point of arrow 56a are (T (n−1, 2), T (n−1, 3), T (n−1, 4), T (n, 1)), so the rotational speed Nr (n−1, 2) may be obtained from the following equation:

$$Nr ( n - 1 , 2 ) = 60 \div [ T ( n , 1 ) + T ( n - 1 , 2 ) + T ( n - 1 , 3 ) + T ( n - 1 , 4 ) ] .$$

Similarly, at the point of arrow 56b in (c) of FIG. 7, from the rate of change of the rotational speed of the motor 8, T (n−1, 2)÷T (n, 2) and the most recent one-rotation rotational speed of the motor 8, Nr (n−1, 2), the following is calculated:

$$N ( n , 2 ) = N r ( n - 1 , 2 ) \times T ( n - 1 , 2 ) \div T ( n , 2 ) .$$

Moreover, from the pulses for one full rotation of the motor 8 at the point of arrow 56b, the one-rotation rotational speed Nr of the motor 8 may be calculated using the following equation:

$$Nr ( n - 1 , 3 ) = 60 \div [ T ( n , 1 ) + T ( n , 2 ) + T ( n - 1 , 3 ) + T ( n - 1 , 4 ) ] .$$

Similarly, at the point of arrow 56c in (d) of FIG. 7, from the rate of change of the rotational speed of the motor 8, T (n−1, 3)÷T (n, 3), and the most recent one-rotation rotational speed Nr (n−1, 3), the following is calculated:

$$N ( n , 3 ) = N r ( n - 1 , 3 ) \times T ( n - 1 , 3 ) \div T ( n , 3 ) .$$

Moreover, from the pulses for one full rotation of the motor 8 at the point of arrow 56c, the rotational speed Nr may be calculated using the following equation:

$$Nr ( n - 1 , 4 ) = 60 \div [ T ( n , 1 ) + T ( n , 2 ) + T ( n , 3 ) + T ( n - 1 , 4 ) ] .$$

As described above, the control unit 10 may perform speed detection by the number of times of slits 87 in the rotation detector 85 during one round of the motor 8 by sequentially measuring the rotational speeds N (n, 1), N (n, 2), and N (n, 3). This speed detection control may be easily implemented by modifying the computer program executed by the existing microcomputer of the control unit 10, resulting in only a slight increase in manufacturing cost. In the above-described embodiment, the rotational speed was calculated using the output of the encoder, but it is also possible to calculate the motor rotational speed using the above method with output pulses from a Hall IC that detects the excitation position of a brushless motor or pulse signals of the rotor's identification ID.

### Embodiment 2

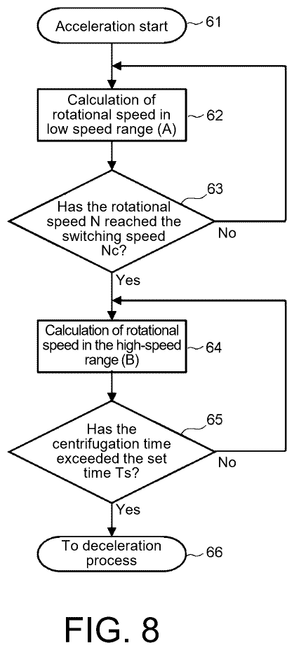

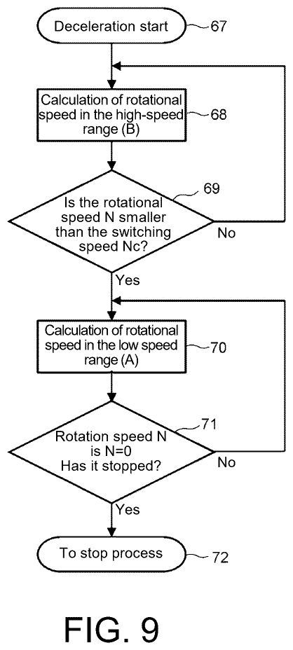

Next, the second embodiment of the present invention will be described using FIG. 3, FIG. 8, and FIG. 9. In the first embodiment, it was assumed that the same speed measurement method was used for all speed ranges. In the second embodiment, instead of using the speed detection method shown in the first embodiment for the entire speed range, speed detection is performed using the method of the first embodiment (pulse time comparison speed detection mode) in the low-speed range (refer to FIG. 3), and in the speed range higher than a certain threshold rotational speed (N_{c}) (refer to FIG. 3), speed detection is performed once per rotation as in the conventional method (normal speed detection mode). The setting of this threshold speed N_{c} is arbitrary, but for example, in the case of using a dedicated rotor 20 for cell washing as shown in FIG. 1, it is preferable to set a rotational speed N_{c} higher than the speed range (rotational speed N₃-N₄) for injecting the cleaning solution 17 as the threshold. By setting the threshold speed N_{c} in this way, high-precision rotation number detection can be achieved in the pulse time comparison speed detection mode for all rotor 20 rotation controls in the cleaning solution injection process shown by enclosed number 1 in FIG. 3, the supernatant discharge process shown by enclosed number 3, and the oscillation process shown by enclosed number 4.

FIG. 8 is a flowchart showing the speed detection procedure of the centrifuge 1 according to the second embodiment of the present invention. The control of the second embodiment may be realized by software through the execution of a computer program by the microcomputer of the control unit 10. The control shown in FIG. 8 begins when the user presses the start button for centrifugal separation operation from the operation display panel 12 of the centrifuge 1 and the motor 8 is started (step 61). First, the microcomputer (not shown) of the control unit 10 executes the rotational speed calculation process (A) by the pulse time comparison speed detection mode (step 62). The microcomputer that has detected the rotational speed N of the motor 8 in the rotational speed calculation process (A) determines whether the rotational speed N has reached the threshold speed N_{c} for switching (step 63). In the case where the threshold speed N_{c} for switching has not been reached in step 63, the process returns to step 62. In the case where the switching speed has been reached in step 63, the microcomputer switches to speed detection by the rotational speed calculation process (B) in the normal speed detection mode and continues to detect the rotational speed N of the motor 8 (step 64).

The microcomputer continues the speed detection of the rotational speed calculation process (B) in step 64 while determining whether the operation time of the centrifugal separation has exceeded a set time Ts set by the user (step 65), and returns to step 64 if it has not elapsed. In step 65, if the set time Ts has elapsed, the process transitions to the deceleration process shown in FIG. 9 (step 66).

FIG. 9 is a flowchart continuing from FIG. 8, and step 67 is a process continuing from step 66. When the deceleration process starts, the rotational speed of the motor 8 is calculated by the rotational speed calculation process (B) (step 68). Next, the microcomputer that has detected the rotational speed N of the motor 8 determines whether the rotational speed N has become smaller than the threshold speed N_{c} for switching (step 69). In this case, if the rotational speed N is equal to or greater than the threshold speed N_{c} for switching, the process returns to step 68. In the case where the rotational speed N has fallen below the threshold speed N_{c} for switching, the microcomputer of the control unit 10 switches to speed detection by the rotational speed calculation process (A) in the pulse time comparison speed detection mode and continues to detect the rotational speed N of the motor 8 (step 70). In step 71, the microcomputer of the control unit 10 determines whether the motor 8 has stopped (rotational speed N=0) (step 71). In step 71, if the rotation of the motor 8 continues, the process returns to step 70, and if the motor 8 has stopped, the process ends (step 72).

The second embodiment describes a method for switching the rotational speed calculation process of the motor 8 between the pulse time comparison speed detection mode and the normal speed detection mode, but the method in FIG. 8 and FIG. 9 assumes that the rotation of the motor 8 transitions from low speed to high speed. However, in the supernatant discharge process indicated by the enclosed number 3 in FIG. 3 and the oscillation process indicated by the enclosed number 4, the control is only in the low-speed rotation range where the rotational speed does not reach the threshold speed N_{c} for switching the speed detection mode. In this case, the control may be performed without using the rotational speed calculation process (B) for the high-speed range in FIG. 8 and FIG. 9.

The present invention has been described based on two embodiments, but the present invention is not limited to the above-described embodiments, and various modifications are possible within the scope that does not deviate from its spirit. For example, in the above-described embodiments, the microcomputer of the control unit 10 that controls the centrifuge 1 is configured to perform speed detection, but the present invention may also be applied when another microcomputer monitors the rotational speed of the motor 8 to detect abnormalities.

### REFERENCE SIGNS LIST

1 Centrifuge
2 Chassis (frame)
2a Base part
3 Chamber
4 Rotor room
5 Foot part
6 Door
6a Hinge
7 Drain hose
7a Discharge port
8 Motor
9 Crown
10 Control unit
12 Operation display panel
13 Pillar
14 Damper
17 Cleaning solution
18 Cleaning solution supply pipe
19 Nozzle
20 Rotor
21 Rotation axis guide member
22 Rotor plate
23 Bottom surface part
25 Cleaning solution distribution element
25a Cleaning solution inlet
25b Cleaning solution passage
25c Cleaning solution injection port
27 Holding part
31 Test tube holder
40 Test tube
81 Motor housing
82 Rotation axis
83 Flange part
83a Screw hole
85 Rotation detector
86 Encoder disk
87 Slit
88 Photointerrupter
90 Output signal
120 Rotor
122 Mounting hole
123 Ring part
124 Identifier
A1 Rotation axis line (of the motor)

What is claimed is:

1. A centrifuge, comprising:
a rotor for holding a sample;
a motor for rotationally driving the rotor;
a rotation detector for detecting rotation of the motor; and
a control unit for controlling the rotation of the motor based on an output from the rotation detector,
wherein the rotation detector generates M-number of pulse signals (where M≥1) per rotation of the motor, and
in an n^{th} speed detection, the control unit
compares a time interval T (n, m) of an immediately preceding pulse signal detected by the rotation detector (where m indicates an m^{th} pulse in one round, and 1≤m≤M) with a time interval T (n−1, m) of a pulse signal one rotation before the pulse, and
calculates a rotational speed N of the rotor from increase or decrease between the time interval T (n−1, m) and the time interval T (n, m).

2. The centrifuge according to claim 1, wherein the rotational speed N (n, m) is calculated by N (n, m)=N (n−1, m)×T (n−1, m)÷T (n, m).

3. The centrifuge according to claim 2, wherein a rotation control of the rotor comprises an acceleration control that increases the rotational speed of the rotor over time, and a deceleration control that decreases the rotational speed of the rotor over time, and
the speed calculation from the increase or decrease in the time interval T (n, m) of the pulse is performed during acceleration or deceleration of the rotor.

4. The centrifuge according to claim 2, wherein the control unit calculates the speed from the increase or decrease in the time interval T (n, m) of the pulse in a speed range where the rotational speed of the rotor is lower than a threshold speed, and
in a speed range higher than the threshold speed, a rotational speed of the pulse signal for each rotation of the motor is calculated by N (n)=60/[T (n, 1)+T (n, 2)+ . . . +T (n, m)].

5. The centrifuge according to claim 2, wherein the rotation detector comprises:
a disk attached to a rotation axis of the motor and for transmitting or blocking light; and
a photointerrupter attached to a non-rotating part of the motor,
wherein M-number of pulse signals from the photointerrupter are output per rotation of the motor.

6. The centrifuge according to claim 2, wherein the rotation detector comprises multiple magnets attached to the rotor; and
a magnetic detection element attached to a non-rotating part near the rotor,
wherein M-number of pulse signals from the magnetic detection element are output per rotation of the motor.

7. A centrifuge comprising:
a rotor for holding a sample;
a motor for rotationally driving the rotor;
a rotation detector for detecting rotation of the motor; and
a control unit for controlling rotation of the motor based on an output from the rotation detector,
wherein the rotation detector comprises a pulse time comparison speed detection mode that performs multiple speed detections within one round of the motor, and a normal speed detection mode that performs speed detection for each round of the motor, and
the control unit
detects a rotational speed of the motor in the pulse time comparison speed detection mode when the speed is lower than a switching threshold of speed detection mode, and
detects the rotational speed of the motor in the normal speed detection mode when the speed is equal to or higher than the switching threshold of speed detection mode.

8. The centrifuge according to claim 7,
wherein the rotation detector generates M-number (where M>1) of pulse signals per rotation of the motor, and
the control unit
detects, in the pulse time comparison speed detection mode, a time interval T (n, m) of an immediately preceding pulse signal detected by the rotation detector and a time interval T (n−1, m) of a pulse signal one full rotation before, and
calculates speed by: rotational speed N (n, m)=N (n−1, m)×T (n−1, m)÷T (n, m).

9. The centrifuge according to claim 7,
wherein the rotation detector generates M-number (where M>1) of pulse signals per rotation of the motor, and
the control unit
detects, in the pulse time comparison speed detection mode, a sum of time intervals T (n−1, m=1, . . . M) of pulse signals from an immediately preceding pulse detected by the rotation detector to one full rotation before, and
each time when detecting a pulse signal width P (n, m), calculates speed by: rotational speed N (n, m)=60/[T (n−1, 1)+T (n−1, 2)+ . . . +T (n−1, m)]×T (n−1, m)÷T (n, m).
